(19) United States
(12) Patent Application Publication
(10) Pub. No.: US 2026/0084570 A1
(43) Pub. Date: Mar. 26, 2026

(54) RV WITH CHARGE SCHEDULE GENERATION SYSTEM AND METHODS

(71) Applicant: Thor Tech, Inc., Elkhart, IN (US)

(72) Inventors: Simon Wespel, Waldsee (DE); James Kane, Detroit, MI (US)

(73) Assignee: Thor Tech, Inc., Elkhart, IN (US)

(21) Appl. No.: 19/334,353

(22) Filed: Sep. 19, 2025

Related U.S. Application Data
(60) Provisional application No. 63/697,076, filed on Sep. 20, 2024.

(51) Int. Cl. B60L 53/64; B60L 58/12

(52) U.S. Cl. CPC B60L 53/64; B60L 58/12; B60L 2200/28; B60L 2240/70; B60L 2240/80; B60L 2250/16; B60L 2260/54

(57) ABSTRACT

A recreational vehicle (RV) may include a battery, a charging receptacle electrically coupled to the battery, a power measurement device electrically coupled to the charging receptacle, and a charge schedule generation system. The charge schedule generation system may include at least one processor communicatively coupled to the battery and the power measurement device and at least one non-transitory memory module communicatively coupled to the processor. Machine readable instructions of the non-transitory memory module may cause the processor to generate a charge schedule based on incoming power as measured by the power measurement device, a desired state of charge of the battery, and historical trends as to when peak charging hours occur. The at least one processor may further charge the battery according to the charge schedule.

### CROSS-REFERENCE TO RELATED APPLICATIONS

This application claims the benefit of U.S. Provisional Application Ser. No. 63/697,076, filed Sep. 20, 2024.

### BACKGROUND

The present disclosure relates to recreational vehicles. Specifically, the present disclosure relates to power systems of recreational vehicles.

### BRIEF SUMMARY

According to the subject matter of the present disclosure, a recreational vehicle (RV) with a charge schedule generation system is provided. Contemplated RVs include a charging receptacle and a power measurement device electrically coupled to the charging receptacle. Moreover, the charge schedule generation system is utilized to generate a charge schedule to charge RV batteries based on power measured by the power measurement device, a desired state of charge (SOC) of the RV batteries, and historical trends as to when peak charging hours occur.

As the grid is tied to homes, campground sites, and various charging stations, the grid may be strained during certain periods of time. As such, the grid may have different capacities for charging batteries of an RV at during certain periods of time. For example, the grid may be overworked during peak charging hours (e.g., when other users are pulling high amounts of power from the grid and power on the grid is limited). Peak charging hours may correspond to when it is particularly hot outside and users are pulling power from the grid to power air-conditioning units for homes. Peak charging hours may also coincide with periods of time in which most users utilize energy-consuming devices, such as when most users are home and awake during the time between 6:00 PM to 10:00 PM. As such, historical trends as to when peak charging hours occur may be predicted based on time of day or weather conditions. The cost of power from the grid fluctuates depending on how much power is being drawn from the grid by various users. As such, power may be more expensive during peak charging hours.

Generally, when an RV is plugged into an external power source, the RV batteries are charged independent of the strain on the grid. The charger may attempt to pull power from the grid to charge the RV at full capacity as quickly as possible, resulting in high energy bills and additional strain on the grid when the RV is charged during peak charging hours. Such charging is inefficient and costly, particularly when the RV is planned to be parked for a period of time longer than a period of time that it would take to charge the RV to full capacity during peak charging hours. These same issues of peaking charging hours may also occur at campgrounds, which may charge/power multiple RVs at a time. Moreover, campground charging infrastructure is often dated and not capable of handling charging demands of RVs, especially RVs including batteries.

Thus, the present disclosure recognizes the need for generating a charge schedule based on a desired SOC of the RV batteries (including how long the RV is to be plugged into the external power source (e.g., the grid or campground), the power supplied to the RV as measured by the power measurement device, and historical trends as to when peak charging hours occur.

The present disclosure is directed to a charge schedule generation system. Specifically, the present disclosure is directed to generating a charge schedule for electric RVs based on a desired SOC of the battery of the RV, power supplied to the RV as measured by the power measurement device, and historical trends as to when peak charging hours on the grid occur. The user of the RV may input how long the RV is to be plugged into the charger. Alternatively, the charge schedule generation system may predict how long the RV is to be plugged into the charger and generate a charge schedule based on such a prediction. Embodiments of the present disclosure generate the charge schedule to reduce strain on the grid. Generation of the charge schedule also reduces costs of charging the RV, as the RV is charged during non-peak charging hours as opposed to peak charging hours when power is more expensive.

The present disclosure is also directed to campground charging management. Specifically, the present disclosure is directed to managing power to multiple RVs at a campground, distributing power based on a desired SOC of the RVs and campground power data (e.g., loads on the campground at particular times).

The present disclosure also relates to RVs. RVs encompassed by the present disclosure include motorized recreational vehicles, like motor homes and other vehicles with their own motor and drivetrain, and include trailer-type recreational vehicles, which include fifth wheel trailers and other types of towable campers, toy haulers, etc. It is noted that while the present disclosure specifically references RVs, the present disclosure may also be applied to the charging schedule generation for any vehicle with a battery.

In accordance with one embodiment of the present disclosure, a recreational vehicle (RV) may include an RV body enclosing a living area supported by a chassis, a battery, a charging receptacle electrically coupled to the battery, a power measurement device electrically coupled to the charging receptacle, and a charge schedule generation system. The charge schedule generation system may include at least one processor communicatively coupled to the battery and the power measurement device and at least one non-transitory memory module communicatively coupled to the at least one processor and storing machine readable instructions that, when executed by the at least one processor, may cause the at least one processor to measure an incoming power at the charging receptacle using the power measurement device when the charging receptacle is coupled to an external power source. The at least one processor may also determine a desired state of charge of the battery, access a database including historical trends as to when peak charging hours occur, and generate a charge schedule based on the incoming power as measured by the power measurement device, the desired state of charge of the battery, and the historical trends as to when peak charging hours occur. The at least one processor may further charge the battery according to the charge schedule.

In accordance with another embodiment of the present disclosure, a method of generating a charge schedule for an RV may include measuring an incoming power at a charging receptacle using a power measurement device when the charging receptacle is coupled to an external power source, determining a desired state of charge of an RV battery, and accessing a database comprising historical trends as to when peak charging hours occur. The method may further include generating a charge schedule based on the incoming power as measured by the power measurement device, the desired state of charge of the RV battery, and the historical trends as to when peak charging hours occur, and charging the RV battery according to the charge schedule.

In accordance with another embodiment of the present disclosure, a campground charging system may include a plurality of shore power connections. The plurality of shore connections may be electrically coupled to a charging receptacle of a recreational vehicle (RV) including a battery. The campground charging system may also include a power measurement device electrically coupled to the plurality of shore power connections, and a campground charge schedule generation system. The campground charge schedule generation system may include at least one processor communicatively coupled to the battery and the power measurement device and at least one non-transitory memory module communicatively coupled to the at least one processor and storing machine readable instructions that, when executed by the at least one processor, cause the at least one processor to measure an incoming power at the plurality of shore connections using the power measurement device and determine a desired state of charge of the battery of the RV. The at least one processor may further access a database including historical trends as to when peak charging hours occur and generate a charge schedule based on the incoming power as measured by the power measurement device, the desired state of charge of the battery of the RV, and the historical trends as to when peak charging hours occur. The processor may further charge the battery of the RV according to the charge schedule.

Although the concepts of the present disclosure are described herein with primary reference to RVs, it is contemplated that RVs encompassed by the present disclosure include motorized recreational vehicles, like motor homes and other vehicles with their own motor and drivetrain, and include trailer-type recreational vehicles, which include fifth wheel trailers and other types of towable campers, toy haulers, etc. It is noted that while the present disclosure specifically references RVs, the present disclosure may also be applied to the charging schedule generation for any vehicle with a battery.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1 is a side view of an RV with a charging receptacle, according to one embodiment of the present disclosure;

FIG. 2 is block diagram of a charge schedule generation system, according to one embodiment of the present disclosure;

FIG. 3 is a block diagram of a decision tree of a charge schedule generation system, according to one embodiment of the present disclosure;

FIG. 4 is a graphical representation of a first charge schedule generated by the charge schedule generation system, according to one embodiment of the present disclosure; and

FIG. 5 is a graphical representation of a second charge schedule generated by the charge schedule generation system, according to one embodiment of the present disclosure.

### DETAILED DESCRIPTION

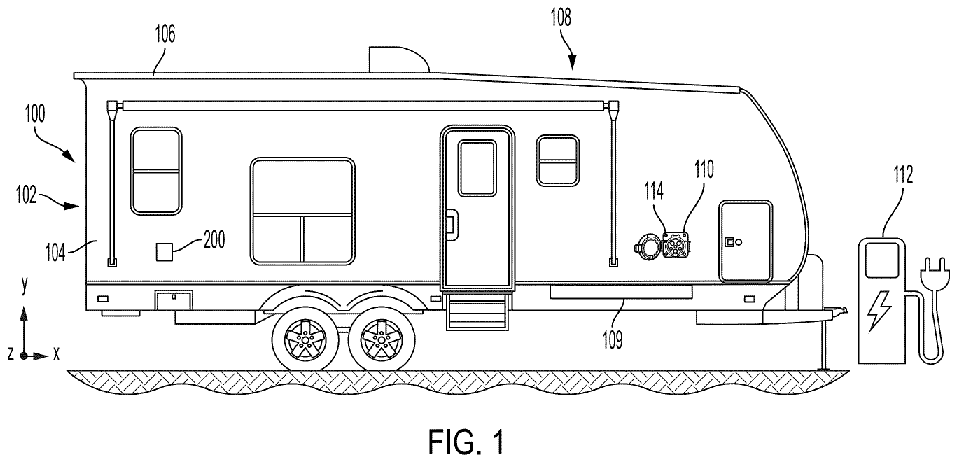

FIG. 1 depicts an RV 100 with an RV body 102. The RV body 102 includes RV sidewalls 104 and an RV roof 106. The RV body 102 encloses an RV living space 108 where passengers reside. The RV 100 further includes a battery 109 and a charging receptacle 110 (e.g., charging port) electrically coupled to the battery 109 (or also electrically coupled to a charge schedule generation system/power management system of the RV), where an external power source 112 may be inserted therein. The battery 109 may be used to power various electrical systems of the RV 100, such as lights, appliances, or a drivetrain of the RV 100 (such as electric motors that propel the wheels of the RV 100). The RV 100 further includes a power measurement device 114 electrically coupled to the charging receptacle 110 that measures power at the charging receptacle 110 when the RV 100 is plugged into an external power source 112 (e.g., when plugged into a charger, an outlet, shore connection, or the grid). The RV 100 further includes a charge schedule generation system 200 (referred to herein as “the system 200”).

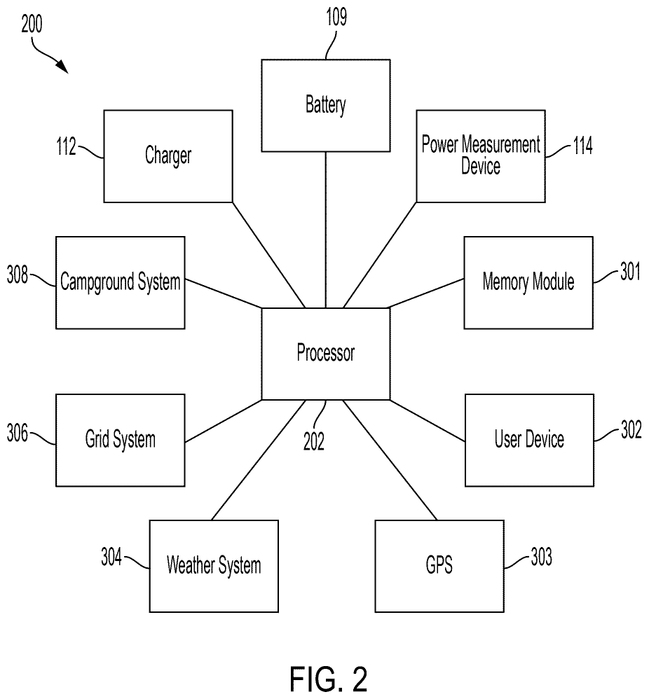

Referring now to FIG. 2, the charge schedule generation system 200 includes at least one processor 202 communicatively coupled to various systems or devices. In embodiments, the processor 202 of the charge schedule generation system 200 may be communicatively coupled to a at least one non-transitory memory module 301 (e.g., a memory module 301), a user device 302, a global positioning system (GPS) 303, a weather reporting system 304, a grid system 306, a campground power system 308, or any other suitable device. The system 200 may generate the charge schedule based on information obtained by the processor 202 from the various systems and devices, as described further below. The memory module 301 may include machine readable instructions that, when executed by the processor, cause the processor to perform various functions as described herein.

In embodiments, the machine readable instructions may cause the processor 202 to measure the incoming power at the charging receptacle 110 using the power measurement device 114 when the charging receptacle 110 is coupled to the external power source 112. It is noted the power measurement may be calculated by measuring voltage and current to obtain the measured power. The processor 202 may further determine a desired state of charge of the battery 109, access a database including historical trends as to when peak charging hours occur (as discussed further below). The processor 202 may also generate a charge schedule based on the incoming power measured by the power measurement device 114, the desired SOC of the battery 109, and the historical trends as to when peak charging hours occur. The processor 220 may also charge the battery 109 according to the charge schedule. Moreover, as described further herein, the processor 220 may also charge the battery 109 according to historical battery 109 usage by the RV 100.

Although a single battery 109 is depicted in FIG. 1, embodiments of the present disclosure include RVs including any number of batteries 109 of the RV 100.

The charging receptacle 110 and the power measurement device 114 may be communicatively coupled to the processor 202 of the system 200. The charging receptacle 110 may be an AC input receptacle. As such, the charging receptacle may be operable to be coupled to an AC output receptacle by way of a cable assembly (not shown). The charging port 110 may also be a receptacle configured to receive a J1772 connector, a CCS connector, or a NASC connector as non-limiting examples.

The power measurement device 114 may measure power provided by the external power source 112 to the charging receptacle 110. In some embodiments, the power measurement device 114 may include a voltmeter. The voltmeter may measure the voltage supplied by the external power source 112 to the charging receptacle 110. The measurement of power/voltage by the power measurement device 114 may generally correspond to a condition of the grid 306. For example, the voltage measured by the power measurement device 114 may be lower during peak charging hours when compared to the voltage applied during non-peak charging hours, as the grid 306 is unable to provide full voltage through the charger during peak charging hours (e.g., when power is being drawn at the same time to power many households/businesses and the grid may be strained). The charge schedule generated by the system 200 may be based in part on the power/voltage measurement measured by the power measurement device 114, as discussed further below.

As noted hereinabove, the system 200 may include or be communicatively coupled to the user device 302. The user device 302 may be a device within the RV 100, such as within the living space 108. The user device 302 may also be included within the head unit of the RV 100, such as within the cockpit area. Moreover, the user device 302 may be a device external to the RV 100, such as a user phone, computer, tablet, or any other suitable device. The user device 302 may include a graphical user interface that displays charging information regarding the charging status of the battery 109 and energy usage by the RV 100. The desired SOC may be determined through an entry into the user device 302. As such, the user may input information into the graphical user interface, such as a time period that the RV 100 is to be plugged into the external power source 112 or a desired state of charge (SOC). For example, the user may input that the RV 100 is going to be plugged into the charger for the next 48 hours, and the user desires that the battery 109 be charged to 80% capacity. The user may also input how long it is going to be until the RV 100 is to be charged next, where the user is planning to drive the RV 100, how long the RV 100 will be off grid 306, or other relevant factors so that the system 200 may automatically generate a desired SOC. The charge schedule of the RV 100 generated by the system 200 may be based in part on the time period the RV 100 is to be plugged into the external power source 112, where the user is planning to drive the RV 100, how long the RV 100 will be off grid 306, whether there is an external power source 112 at a destination the user is planning to drive the RV 100, whether charging stations exist along the route to the destination the user is planning to drive the RV 100, or the desired SOC.

In embodiments, the desired SOC may include the period of time that the RV 100 is planned to be plugged into the external power source 112. The processor 202 may send a notification to the user device 302 when the RV is plugged into the external power source 112 to prompt the user to input the period of time that the RV 100 is planned to be plugged into the external power source 112. Although the external power source 112 is depicted as an EV charger in FIG. 1, it should be understood that the present disclosure contemplates embodiments in which the external power source 112 is a receptacle of a home, business, a charger/shore power station at a campground, or any other external power source to charge the battery 109 of the RV 100.

The system 200 may access a database including historical trends as to when peak charging hours occur and generate the charge schedule based on the historical trends. These historical trends may be recorded and recognized based on a history of the incoming power measured by the power measurement device 114. Moreover, the historical trends may be tied to various conditions other than the incoming power measured by the power measurement device 114, such as time of day, location, time of week/year, weather conditions, holidays, historical power usage by the RV 100, or any other factor/condition that may affect power availability on the grid 306. The processor 202 may store incoming power at the charging receptacle into the database, and use such data as historical trends when determining the charge schedule. Moreover, the system 200 may withdraw the historical trends from a database that is connected to a plurality of RVs. As such, the database may include historical trends as to when peak charging hours occur from a plurality of RVs, such as the incoming power measured by the power measurement devices 114 of a plurality of RVs. This may result in more accurate predictions by the system 200 as to when peak charging hours occur.

For example, the system 200 may recognize that peak charging hours exist between the hours of 6:00 PM and 10:00 PM, as most people are home and using power consuming devices that are powered/charged by the grid. When the system 200 recognizes that peak charging hours will end at 10:00 PM, and the user has inputted that the RV 100 will be plugged into the external power source 112 for the next 48 hours, the system 200 will wait to charge the battery 109 of the RV 100 during non-peak charging hours so that money is saved and strain on the grid is lessened, as power companies often charge more during peak hours. However, if the desired SOC is unable to be met without charging during peak charging hours, the system 200 may charge the battery 109 during peak charging hours to the extent necessary to reach the desired SOC. A notification may be sent to the user through the user device 302 when the battery 109 will not be charged to the desired SOC. Moreover, a notification may be sent to the user device 302 when the battery 109 requires charging during peak charging hours in order for the battery 109 to reach the desired SOC. The system 200 may prompt the user through the user device to accept or decline charging during peak charging hours; alternatively, the system 200 may be set to a default charge or no charge condition during peak charging hours. The processor 202 of the system may decrease power draw from the external power source 112 during peak charging hours and decrease power draw from the external power source 112 during non-peak charging hours.

The system 200 may also consider historical trends as to when the RV 100/user utilizes power within the RV 100. For example, the system 200 may consider historical trends as to when a user of the RV 100 pulls the most power from the battery 109 of the RV 100. Utilizing this data, the system 200 may predict the SOC of the battery 109 based on the historical trends as to when the RV 100 utilizes power, and generate the charge schedule based on such information. The historical trends as to power usage of the RV 100 may be based on location of the RV 100, past usage of power at a particular location/time, weather (e.g., whether an air-conditioning unit will be utilized), or any other factor that may affect power usage by a user of the RV 100.

In some embodiments, the user may fail enter the desired SOC. In such embodiments, the system 200 may have a default setting to automatically charge the battery 109 during non-peak charging hours. Alternatively, the system 200 may have a default setting to automatically charge the battery 109 to full capacity regardless of whether it is peak/non-peak charging hours. In further embodiments, the system 200 may charge the battery 109 of the RV 100 depending on a location of the RV 100 as determined by the GPS 303 or the type of external power source 112 that the RV 100 is plugged into. For example, if the RV 100 is at a charging station or at a campsite, the system 200 may automatically charge the battery 109 to full capacity regardless of whether it is peak/non-peak charging hours, as it is expected that the RV 100 may not be parked at the charging station or the campsite for an extended time period. On the other hand, if the RV 100 is plugged into a charger at the user's home or in a residential area, then the system 200 may not charge the battery 109 during peak charging hours, as it is expected that the RV 100 may be parked at the home for an extended time period. The user may override the default settings of the system 200 through the user device 302, inputting the time period the RV 100 is going to be plugged into the external power source 112 or the desired SOC of the battery 109.

The system 200 may also charge the battery 109 based on recognized patterns/historical data. The historical data may include how long the RV 100 has been plugged into the external power source 114 at a particular location. For example, the system 200 may recognize that the RV 100 is typically plugged into the external power source 112 at the home of the user during the entire month of January. As such, the system 200 will generate the charge schedule based on this time period that the RV 100 is plugged into the external power source 112.

Moreover, the system 200 may be communicatively coupled to a calendar system of the user device 302. The processor 202 may determine the period of time that the RV 100 is planned to be plugged into the external power source 112 through the calendar of the user device 302. As such, the system 200 may recognize that the RV 100 is going to be parked at a campsite for two weeks based on the calendar stored on the user device 302. The charge schedule may be generated by the system 200 based on the time period the RV 100 is going to be parked at the campsite and plugged into the external power source 112, the time period determined by the calendar of the user device 302.

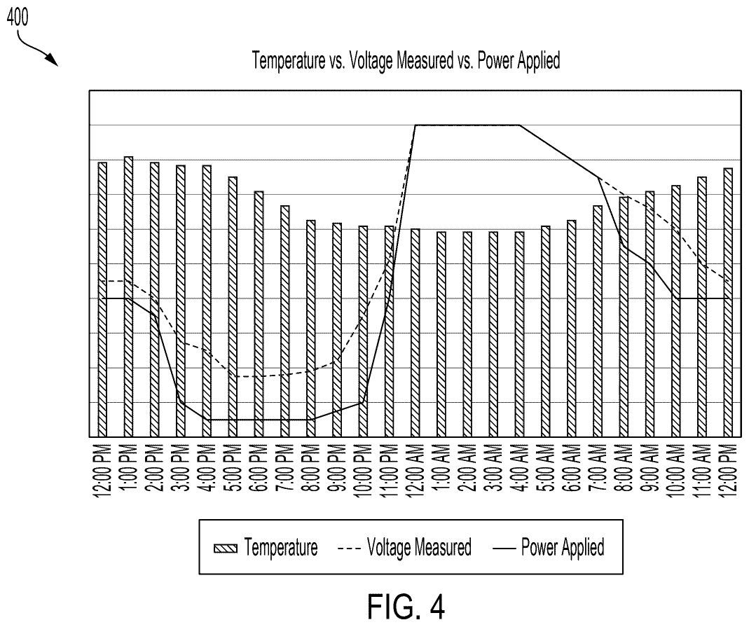

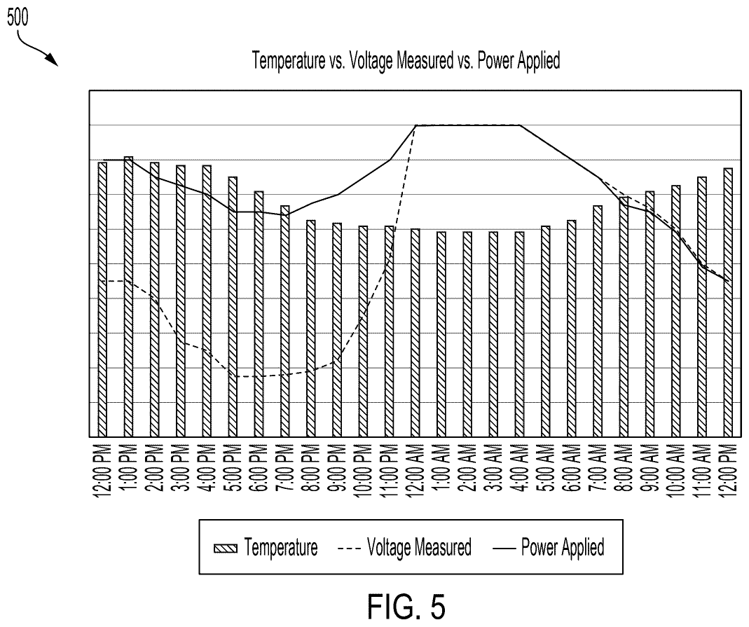

The system 200 may include logic that predicts when peak charging hours will occur based on historical trends/patterns and generate a charge schedule based on those historical trends. The system 200 may obtain weather information from the weather reporting system 304, predict peak charging hours based on the weather information, and generate the charge schedule based on the predicted peak charging hours. In some embodiments, grid information, such as peak charging hours, can be provided by energy providers or third parties with grid information. For example, the weather may be hot outside and the time of day may be 6:00 PM on a weekday. The system 200 may recognize that when similar weather conditions were experienced in the past at 6:00 PM on a weekday, peak charging hours did not end until 1:00 AM, as most people are running their air-conditioners longer to account for the hot weather. As such, the system 200 may generate a charge schedule based on the historical trend/recognized pattern. The historical trends as to when peak charging hours occur may also be based on historical power measurements linked to time of day/week/year as measured by the power measurement device. As noted hereinabove, the historical power measurements may be based on power measurements of the RV 100, or a plurality of RVs. Examples regarding charge schedules based on power measured by the power measurement device 114 are depicted in FIGS. 4 and 5 and discussed further below.

Upon being plugged into the external power source 112, the system 200 may send a notification to the user device 302. The notification to the user device 302 may prompt the user to input the time period that the RV 100 will be plugged into the external power source 112 and the desired SOC when the RV 100 is unplugged from the external power source 112 (e.g., at the end of the time period that the user has entered). The system 200 may generate the charge schedule based on the inputs from the user on the user device 302, taking into account predicted peak charging hours based on historical trends. If the system 200 recognizes that the battery 109 of the RV 100 can reach the desired SOC at the end of the period of time that the RV 100 is plugged into the external power source 112 without charging during the predicted peak charging hours (as described above), then the system 200 will charge the battery 109 during non-peak charging hours to save money and lessen strain on the grid.

The user of the RV 100 may input how long the RV 100 is to be plugged into the external power source 112. Alternatively, the charge schedule generation system 200 may predict how long the RV 100 is to be plugged into the external power source 112 based on location of the RV 100 and previous charging sessions at that particular location, and generate a charge schedule based on such a prediction.

Alternatively, when the system 200 recognizes that the battery 109 cannot reach the desired SOC after the period of time that the RV 100 is plugged into the charger unless the battery 109 is charged during peak charging hours, then the system 200 may charge the battery 109 during peak charging hours, but only to the extent that charging during peak charging hours is required to charge the battery 109 to the desired SOC. Moreover, the system 200 may lessen or increase charging of the battery 109 based on whether peak/non-peak charging hours are present/predicted, lessening power input during peak charging hours and increasing power input during non-peak charging hours. As such, the system 200 may stop charging during peak hours, or reduce the rate of charging during peak hours.

When the system 200 recognizes that the battery 109 cannot be charged to the desired SOC without charging during peak charging hours, the system 200 may send a notification to the user device 302, notifying the user that charging may occur during peak charging hours. The user may accept the charge schedule generated by the system 200 through the user device 302. Alternatively, the user may reject the charge schedule generated by the system, indicating that the user does not want the system 200 to charge the battery 109 during peak charging hours, regardless of whether the battery 109 will fail to reach the desired SOC after the period of time that the RV 100 is plugged into the external power source 112.

Embodiments of the present disclosure also encompass methods of utilizing the system 200 described here. As such, the present disclosure encompasses method of charging the battery 109 of the RV 100 to minimize costs and lessen strain on the grid.

Specifically, methods of the present disclosure may include measuring the incoming power at the charging receptacle 110 using the power measurement device 114 when the charging receptacle 110 is coupled to the external power source 112, and determining a desired SOC of the RV battery 109. The method may further include accessing the database including the historical trends as to when peak charging hours occur and generating a charge schedule based on the incoming power as measured by the power measurement device 114, the desired SOC of the RV battery 109, and the historical trends as to when peak charging hours occur. The method may further include charging the RV battery 109 according to the charge schedule.

The method may further include sending a notification to the user device 302 when the RV 100 is plugged into the external power source 112 to prompt the user to input the period of time that the RV is planned to be plugged into the external power source 112. In embodiments, the method may also include determining the period of time that the RV 100 is planned to be plugged into the external power source 112 through the calendar of the user device 302. Moreover, the method may also include decreasing power draw from the external power source 112 during peak charging hours and increasing power draw from the external power source 112 during non-peak charging hours.

Although embodiments are described above with reference to the grid, it should be understood that embodiments incorporating measuring power drawn from campgrounds are also contemplated. Moreover, embodiments of the present disclosure also include incorporation of a campground charging system 308. For example, the processor may measure the incoming power at the charging receptacle 110 through the power measurement device 114 when the charging receptacle 110 is connected to a campground power source. Such measurement may be used in determining the charge schedule generation. Moreover, the historical trends as to when peak charging hours occur may be based on previous measurements of incoming power at a campground. As such, the system 200 may recognize that the RV 100 is connected to the campground power source, and generate the charge schedule based on historical trends at campsites generally, or particular campsites that the RV 100 or other RVs have visited.

Moreover, the campground charging system 308 may also generate a charge schedule. As such, the campground charging system 308 may include a plurality of shore power connections electrically coupled to the charging receptacle 110 of the RV 100. The power measurement device 114 may be coupled to the plurality of shore power connections. The campground charging system 308 may include a campground charge schedule generation system that includes at least one processor and non-transitory memory module communicatively coupled to the at least one processor and storing machine readable instructions that cause the at least one processor to perform various functions. The campground charge schedule generation system may measure the incoming power at the plurality of shore connections using the power measurement device 114, determines the desired SOC of the battery 109 of the RV 100, determines a SOC of the battery 109, and accesses a database including historical trends as to when peak charging hours occur at the campsite. The campground charging system 308 may further generate a charge schedule based on the incoming power, the desired SOC of the battery 109, and the historical trends as to when peak charging hours occur and then charge the battery 109 of the RV 100 in accordance with the charge schedule.

Embodiments of the present disclosure further include communication between the charge schedule generation system 200 of the RV 100 and the campground charging system 308. As such, the campground charging system 308 may gain information regarding SOC of the battery 109, desired SOC of the battery 109, and historical trends from the charge schedule generation system 200 of the RV 100. The charge schedule generation systems 200 of the RVs 100 may also be communicatively coupled to one another, allowing the charge schedule generation systems 200 to communicate as to when each system 200 is going to pull power from the campground charging system based on the SOC of each of the batteries and the time the RVs are leaving the campground.

The campground charging system 308 may be electrically coupled to a plurality of charging receptacles 110 of a plurality of RVs 100. Moreover, the power measurement device 114 of the campground charging system 308 may measure power at each of the plurality of shore connections. In embodiments, the power measurement device 114 may also measure the power at a circuit of the campground charging system 308. As such, the campground charging system 308 may measure the power to each individual RV, or at a central circuit that measures power to all of the RVs (or measure the power to each circuit that is at the campground charging system 308). The campground charging system 308 may generate the charge schedule based on how long each individual RV is planned to be parked at the campground and the desired SOC of each of the batteries 109 of the RVs when they plan to leave the campground.

As noted hereinabove, the system 200 and RV 100 may be communicatively coupled to a plurality of RVs. As such, RVs of a campground may communicate the power supplied to particular RVs through the power measurement devices 114. The systems 200 of multiple RVs may utilize such information to generate charge schedules for each of the particular RVs.

The system 200 may also communicate with the campground charging system 308, determining when the campground charging system 308 experiences the highest loads or when the campground charging system 308 charges the most amount of money during certain time periods. Moreover, the campground charging system 308 may monitor the power supplied to each RV plugged into the campground charging system 308. The campground charging system 308 may monitor power supplied to each individual RV, or simply measure power supplied through a main breaker of the campground charging system 308. The campground charging system 308 may generate charge schedules for the RVs based on such power measurements. The campground charging system 308 may also communicate such power measurements to the systems 200 of the RVs, allowing the RVs to utilize such power measurements when generating charge schedules.

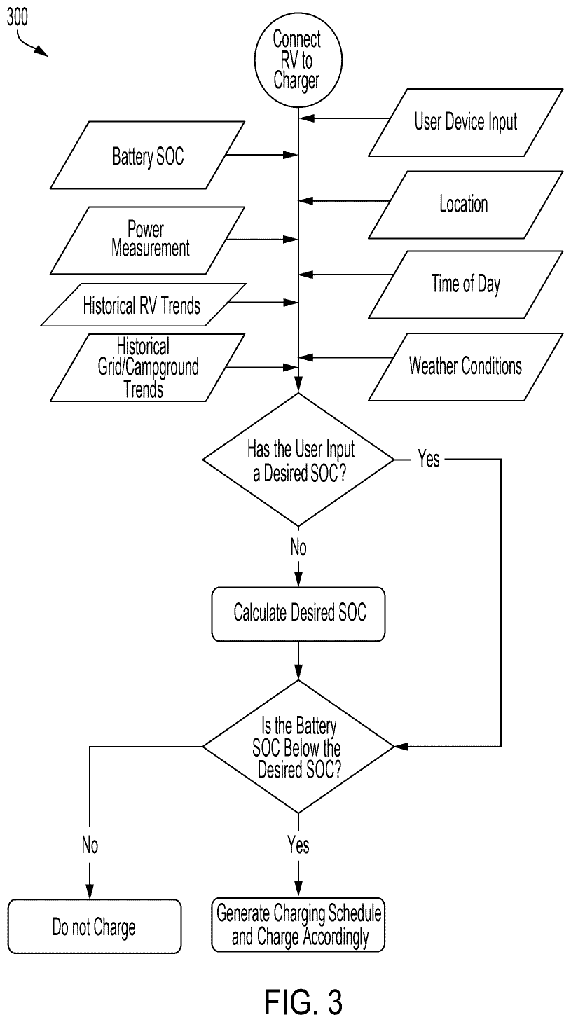

Referring now to FIG. 3, a decision tree 300 incorporating the systems and methods described herein is depicted. Specifically, once the RV 100 is connected to the external power source 112, the system 200 may receive an input from the user device 302, which may include the desired SOC of the battery 109 as input by the user. The system 200 may also receive input from the battery 109, such as the current SOC of the battery 109. The system 200 also considers inputs from various sources such as a power measurement from the power measurement device 114, a location of the RV 100 from the GPS 303 of the RV or a GPS 303 of the user device 302 (and, thus, a location of the external power source 112), a time of day, and weather conditions from the weather system 304. The system 200 may also consider historical grid and campground trends, as discussed further above. As also described above, various other inputs may be considered from the user device (such as the calendar). It should be understood that FIG. 3 is merely exemplary, and any number of the inputs (1-7) in any combination may be utilized, and more inputs may be considered by the system 200 that are not necessarily depicted in FIG. 3.

When the user has not entered the desired SOC on the user device 302, the system 200 calculates the desired SOC based on the inputs from the various sources, as discussed hereinabove. The system 200 then determines whether the battery 109 is below the desired SOC. Alternatively, when the user has entered the desired SOC on the user device 302, the system 200 determines whether the battery 109 is below the desired SOC, as there is no need for a calculation of the desired SOC. The system 200 may also be defaulted to charge the battery 109 of the RV 100 as quickly as possible.

When the battery 109 is below the desired SOC, the system 200 generates a charge schedule based on the received inputs and charges the battery 109 according to the charge schedule. In contrast, when the battery 109 is at or above the desired SOC, the system 200 does not charge the battery 109. It is noted that the system 200 may analyze whether the battery 109 is below the desired SOC not only when the RV 100 is connected to the external power source 112, but may periodically check the SOC of the battery 109 while the RV 100 is connected to the external power source 112, as the battery 109 may deplete while connected to the external power source.

FIG. 4 illustrates a graphical representation of a first charge schedule 400 generated by the charge schedule generation system 200. Specifically, FIG. 4 depicts the first charge schedule 400 generated where the first charge schedule 400 does not charge the battery 109 during peak charging hours. In the first charge schedule 400, the charge schedule generation system 200 recognizes that charging during peak charging hours is not required to bring the battery 109 to the desired SOC before expiration of the period of time that that RV 100 is to be plugged into the external power source 112, such as 24 hours in the depicted example. As depicted in FIG. 4, the voltage measured by the power measurement device 114 (e.g., input voltage, such as 100 VAC-130 VAC) may drop when the temperature is high because more users may be running an air-conditioning unit during such times, increasing strain on the grid 306. The voltage measured by the power measurement device 114 may also drop between the hours of 5:00 PM to 9:00 PM, as most people are utilizing electricity consuming devices in their homes during such hours. As such, the charge schedule generation system 200 may charge at a lowered charging power by reducing the amount of current provided to the battery 109, as it is cheaper to do so and puts less strain on the grid/campsite. In some embodiments, the charge schedule generation system 200 may not charge at all during the peak charging hours, or only a minimum amount required to reach the desired SOC by the expiration of the period of time the RV 100 is to be plugged into the external power source 112.

Once the voltage measured by the power measurement device 114 increases, during the hours in which most people are not using electricity consuming devices in their homes and the temperature has decreased, the charge schedule generation system 200 may apply more current to charge the battery 109 at a higher charging power, as electricity during this period of time is more readily available and cheaper during non-peak charging hours, and such charging lessens strain on the grid 306. Once users begin to use electricity consuming devices when waking up for the day and temperatures begin to rise, the charge schedule generation system 200 may then apply a lessened current to reduce the charging power provided to the battery 109, lessening the strain on the grid 306, and decreasing charging prices. As such, the first charge schedule 400 may result in the cheaper charging for the user, as the battery 109 is charged primarily during non-peak charging hours. As noted above, the voltage measured may be stored to the database as historical trends as to when peak charging hours occur. As such, the system 200 may predict such peak charging hours. Moreover, it is noted that the system 200 may generate a charge schedule without the use of the power measurement device 114, as the system 200 may solely use the prediction as to when peak charging hours occur based on the historical trends as to when peak charging hours occur, and the desired SOC of the battery. Moreover, the charge schedule that is generated by the system 200 may change in real-time, such as when the power measurement device 114 measures less power than the charge schedule anticipated.

FIG. 5 depicts a graphical representation of a second charge schedule 500 generated by the charge schedule generation system 200. In contrast to the first charge schedule 400 depicted in FIG. 4, the second charge schedule 500 depicted in FIG. 5 charges at or near the maximum charging power during peak charging hours because the battery 109 would not reach the desired SOC if the battery 109 was not charged during peak charging hours (because the difference between the current SOC and desired SOC of the battery 109 may be greater in the example depicted in FIG. 5). As such, the second charge schedule 500 may result in a higher charging cost, but still charges the battery 109 to the desired SOC during the period of time that the RV is to be plugged into the external power source 112.

It should be understood that the charge schedule generation system 200 may also determine whether to send power to power consuming devices of the RV 100 (such as light fixtures, AC units, refrigerators, or other components of the RV 100). As such, if the RV 100 is utilizing power consuming devices and connected to the external power source 112, the charge schedule generation system 200 may route power to the power consuming devices rather than the battery 109, or a lessened amount of power to the battery 109. In embodiments, the user may receive an alert on the user device 302 that the RV 100 is unable to charge to the desired SOC if usage of the power consuming devices is not reduced. The charge schedule generation system 200 may further recommend which power consuming devices to power off and the duration that such power consuming devices should be powered off in order to reach the desired SOC by the period of time the RV 100 is to be plugged into the external power source 112. In further embodiments, the charge schedule generation system 200 may automatically shut off the power consuming devices (load shed) so that the battery 109 may reach the desired SOC by the end of the period of time the RV 100 is to be plugged into the external power source 112.

Collectively, the various features of the RV and charge schedule generation system described herein provide for more efficient and cost-effective charging of the RV batteries. Notably, the charge schedule generation system increases charging of the RV batteries during non-peak charging hours and reduces charging during peak charging hours, lessening stress on the grid. Moreover, charge schedule generation system described herein may be communicatively coupled to a campground power management system, which may share data regarding peak/non-peak charging hours with the charge schedule generation system to lessen strain on the campground grid.

For the purposes of describing and defining the present invention it is noted that terms like “near” are utilized herein to represent the inherent degree of uncertainty that may be attributed to any quantitative comparison, value, measurement, or other representation. The term “near” is also utilized herein to represent the degree by which a quantitative representation may vary from a stated reference without resulting in a change in the basic function of the subject matter at issue.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

What is claimed is:

1. A recreational vehicle (RV) comprising:
an RV body enclosing a living area supported by a chassis;
a battery;
a charging receptacle electrically coupled to the battery;
a power measurement device electrically coupled to the charging receptacle;
a charge schedule generation system comprising:
at least one processor communicatively coupled to the battery and the power measurement device;
at least one non-transitory memory module communicatively coupled to the at least one processor and storing machine readable instructions that, when executed by the at least one processor, cause the at least one processor to perform at least the following:
measure an incoming power at the charging receptacle using the power measurement device when the charging receptacle is coupled to an external power source;
determine a desired state of charge of the battery;
access a database comprising historical trends as to when peak charging hours occur;
generate a charge schedule based on the incoming power as measured by the power measurement device, the desired state of charge of the battery, and the historical trends as to when peak charging hours occur; and
charge the battery according to the charge schedule.

2. The RV of claim 1, wherein the processor is communicatively coupled to a user device.

3. The RV of claim 2, wherein the desired state of charge is determined through an entry into the user device.

4. The RV of claim 2, wherein:
the desired state of charge comprises a period of time that the RV is planned to be plugged into the external power source; and
the machine readable instructions stored in the at least one memory module further cause the processor to send a notification to the user device when the RV is plugged into the external power source to prompt a user to input the period of time that the RV is planned to be plugged into the external power source.

5. The RV of claim 2, wherein:
the desired state of charge comprises a period of time that the RV is planned to be plugged into the external power source; and
the machine readable instructions stored in the at least one memory module further cause the processor to determine the period of time that the RV is planned to be plugged into the external power source through a calendar of the user device.

6. The RV of claim 1, wherein the desired state of charge is determined based on a location of the RV and historical data as to how long the RV has been plugged into the external power source at the location.

7. The RV of claim 1, wherein the desired state of charge is determined based on a type of the external power source the RV is plugged into.

8. The RV of claim 1, wherein the historical trends as to when peak charging hours occur are based on previous measurements of incoming power, time of day, or weather conditions.

9. The RV of claim 1, wherein the machine readable instructions stored in the at least one memory module further cause the processor to store the incoming power at the charging receptacle into the database.

10. The RV of claim 1, wherein the database comprises historical trends as to when peak charging hours occur from a plurality of RVs.

11. The RV of claim 1, wherein the machine readable instructions stored in the at least one memory module further cause the processor to decrease power draw from the external power source during peak charging hours and increase power draw from the external power source during non-peak charging hours.

12. A method of generating a charge schedule for an RV, the method comprising:
measuring an incoming power at a charging receptacle using a power measurement device when the charging receptacle is coupled to an external power source;
determining a desired state of charge of an RV battery;
accessing a database comprising historical trends as to when peak charging hours occur;
generating a charge schedule based on the incoming power as measured by the power measurement device, the desired state of charge of the RV battery, and the historical trends as to when peak charging hours occur; and
charging the RV battery according to the charge schedule.

13. The method of claim 12, further comprising sending a notification to a user device when the RV is plugged into the external power source to prompt a user to input a period of time that the RV is planned to be plugged into the external power source.

14. The method of claim 12, further comprising determining a period of time that the RV is planned to be plugged into the external power source through a calendar of the user device.

15. The method of claim 12, further comprising decreasing power draw from the external power source during peak charging hours and increasing power draw from the external power source during non-peak charging hours.

16. A campground charging system comprising:
a plurality of shore power connections, wherein the plurality of shore connections are electrically coupled to a charging receptacle of a recreational vehicle (RV) comprising a battery;
a power measurement device electrically coupled to the plurality of shore power connections;
a campground charge schedule generation system comprising:
at least one processor communicatively coupled to the battery and the power measurement device;
at least one non-transitory memory module communicatively coupled to the at least one processor and storing machine readable instructions that, when executed by the at least one processor, cause the at least one processor to perform at least the following:
measure an incoming power at the plurality of shore connections using the power measurement device;
determine a desired state of charge of the battery of the RV;
access a database comprising historical trends as to when peak charging hours occur;
generate a charge schedule based on the incoming power as measured by the power measurement device, the desired state of charge of the battery of the RV, and the historical trends as to when peak charging hours occur; and
charge the battery of the RV according to the charge schedule.

17. The campground charging system of claim 16, wherein a charge schedule generation system of the RV is communicatively coupled to the campground charge schedule generation system.

18. The campground charging system of claim 16, wherein the plurality of shore connections are electrically coupled to charging receptacles of a plurality of RVs.

19. The campground charging system of claim 16, wherein the power measurement device measures the power at each of the plurality of shore connections.

20. The campground charging system of claim 16, wherein the power measurement device measures the power a circuit of the campground charging system.
